(19) United States
(12) Patent Application Publication
(10) Pub. No.: US 2026/0142703 A1
(43) Pub. Date: May 21, 2026

(54) METHOD OF COMMUNICATION WITH RELAY NODES AND/OR USER EQUIPMENT'S AND COMMUNICATION SYSTEMS THEREOF

(71) Applicant: WISIG NETWORKS PRIVATE LIMITED, Madinaguda, Hyderabad (IN)

(72) Inventor: Pavan Kumar Reddy Manne, Bhongir (IN)

(21) Appl. No.: 19/119,020

(22) PCT Filed: Oct. 12, 2023
(86) PCT No.: PCT/IN2023/050931

§ 371 Date: Apr. 7, 2025

(30) Foreign Application Priority Data
Oct. 12, 2022 (IN) 202241058148

(51) Int. Cl. H04B 7/06; H04B 7/0452; H04L 5/00; H04L 5/14

(52) U.S. Cl. CPC H04B 7/0626; H04B 7/0452; H04L 5/0051; H04L 5/14

(57) ABSTRACT

Embodiments of the present disclosure relate to a method for communication by a base station (BS) with at least one of one or more user equipment's (UEs) and one or more relay nodes. The method comprising transmitting one or more downlink (DL) channel state information reference signals (CSI-RS) by the BS to the UEs and/or relay nodes. Thereafter, receiving by the BS at least one of a DL CSI and one or more SRS from the at least one the UEs and the relay nodes. Further, the method comprises performing at least one of a SU-MIMO, multi-user MIMO, TDD, FDD, and code domain multiplexing of the UEs or relay nodes using the received at least one of a DL CSI and one or more SRS. The BS is configured in one of a cylindrical antenna structure and a structural MIMO antenna structure.

### CROSS-REFERENCE TO RELATED APPLICATIONS

This application claims priority from the Indian Provisional Patent Application Number 202241058148 filed on Oct. 12, 2022, the entirety of which are hereby incorporated by reference.

### TECHNICAL FIELD

Embodiments of the present disclosure are related, in general to communication, but exclusively relate to methods and systems for communicating with user equipment's (UEs) and relay nodes.

### BACKGROUND

Cellular connectivity has become much popular with the advent of 4G-Long Term Evolution (4G-LTE), a wireless standard that vastly improved the connectivity speeds and reduced the price per bit. The latest cellular standard 5G-New Radio (5G-NR) introduced by 3rd Generation Partnership Project (3GPP) is expected to accommodate immersive applications such as augmented and virtual reality with higher data rates, Internet of Things (IoT) applications like industrial monitoring, ultra-reliable and low latency services, mission-critical communications, automation, smart grid, etc. With all these new additions, 5G-NR is expected to generate at least three times more traffic as compared to an average 5G-NR connection. To meet such increased demands of cellular traffic and provide service to a massive number of devices, the industry operators will require to increase the network capacity of the existing cellular deployments. Massive Multiple Input Multiple Output (Massive MIMO) is considered as a key technology for 5G-NR and beyond 5G-NR cellular standards that has the potential to achieve such multi-fold improvements in the network capacity.

Massive MIMO is now a mainstream technology that is part of 4G-LTE, 5G-NR and most certainly beyond 5G cellular systems. It gained prominence as it enabled substantial gains in spectral efficiency in wide area cellular networks. The spectral efficiency (SE) of 4G-LTE system with Massive MIMO is 3× the SE of a 4G-LTE system without Massive MIMO. In 5G-NR, a maximum of 12 orthogonal transmissions aka 12 layers (12 spatial streams or 12 users) can be supported simultaneously on the same time-frequency resources. The next generation 6G standards are looking at the possible evolution of this Massive MIMO technology beyond the current capabilities.

The theoretical foundations of this Massive MIMO technology originate from the concepts of multiple data transmissions using multiple antennas was initially proposed. Many advances have been made since then, eventually leading to the understanding of the Massive MIMO regime. With a large number of antennas at the base station (BS), the network operator can transmit the data to multiple user-equipment's (UEs) on the same time-frequency resources and increase the network capacity, as shown in FIG. 1. In such a scenario, each UE suffers interference from the other UEs (termed as inter-user interference), which degrades the received signal quality at each user. However, with various digital beamforming techniques, this inter-user interference can be minimized, and a multi-fold improvement in the network capacity can be achieved. In line of sight (LOS) conditions, the ability to support multiple such UEs is limited by the angular separation between the channel vectors of the UEs in both azimuth and elevation. This, in turn, is dependent on the spacing between the antenna elements of the two-dimensional (2D) antenna array at the BS. Thus, the physical size of the planar array at the BS limits the user pairing capability. Further, in non-line of sight (NLOS), theoretically, as many users as the number of antennas can be paired for the simultaneous transmissions in case the channel vectors are independent and identically distributed (IID). However, the IID channel fading cannot be realized in practice which significantly impacts the user pairing.

While theoretically, the behavior of MIMO has been understood over many years, in practice, many factors such as the size of the antenna array, spacing between antenna elements (in other words, the aperture of the antenna array), deployment considerations such as indoor vs outdoor, the distance between the antenna array and the users, pilot contamination, etc. affect the performance of gains achieved by these MIMO and Massive MIMO systems. Despite these limitations, many systems have used some form of MIMO and Multiuser Multiple Input Multiple Output (MU-MIMO) concepts in practical deployments. Out of all these, TDD-based deployments play a significant role as the uplink channel can be used to identify the downlink channel, which can then be used to create interference-free transmissions to the users. However, this requires that the users are moving moderately slow, enough density of pilots on the uplink to estimate the channels, and relatively less interference from neighboring cells. Using such techniques, 5G-NR standards define 12-layer transmission using 12 orthogonal reference signal transmissions. For this to succeed, it is inherently assumed that the channel's frequency selectivity is relatively low. Therefore, precoding or beamforming calculation is done over the granularity of something known as Physical Resource Block (PRB) instead of on a subcarrier-basis.

Various testbeds across industry and academia have evaluated the achievable gains with the MU-MIMO and Massive MIMO. The Massive MIMO testbed considered 100 antenna ports at BS and have demonstrated 12 user-pairing on the same time-frequency resources using zero-forcing (ZF) precoder and maximum ratio transmission (MRT). Also, another massive MIMO have considered 64 antenna elements at the BS and have demonstrated 15 user-pairing with localized conjugate multiuser beamforming technique. A Full-Dimension MIMO testbed is demonstrated with 12 user-pairing with 32 antenna ports at BS with signal-to-leakage and noise ratio (SLNR) precoding. All these demonstrations in the above-said testbeds have considered a maximum of 15 users paired in downlink by BS on the same time-frequency resources. None of the existing real-time implementations have demonstrated more than 15 UEs being served on the same time-frequency resources. Further, the BS developed in all these testbeds have a planar antenna array that supports only a limited sector for service. This limiting area of service around the BS has a significant impact on the user pairing. Motivated by the aforementioned details, the MU-MIMO performance is evaluated in real-time for more than 15 user-pairing while considering different antenna structures at the BS.

However, the total achievable gain of Massive MIMO is not known in practical indoor or outdoor settings. While the standards limit to 12 layers and in some cases, demos have shown 15 layers, no study shows the limits of such a deployment in real settings. It is also not known if a sectored deployment or circular deployment for a single-cell setup is optimal or not.

In situations where it is impractical to install optical fiber connections at every cellular site, the deployment of wireless backhaul emerges as a cost-effective and rapidly deployable solution. With the advent of 5G and advanced 5G cellular services operating within the millimeter-wave spectrum, the effective communication range becomes notably smaller. Consequently, a denser deployment of cell sites is necessary to ensure comprehensive coverage. To address this challenge, the introduction of multi-hop relaying can substantially extend the coverage of cellular deployments. The 3rd Generation Partnership Project (3GPP) has standardized support for multi-hop relaying in 5G-NR, denoted as Integrated Access and Backhaul (IAB) in Release 16 specifications. IAB is regarded as a cost-effective deployment technique that serves as a viable alternative to optical cellular backhaul.

### SUMMARY

The shortcomings of the prior art are overcome and additional advantages are provided through the provision of method of the present disclosure.

Additional features and advantages are realized through the techniques of the present disclosure. Other embodiments and aspects of the disclosure are described in detail herein and are considered a part of the claimed disclosure.

In one aspect of the present disclosure a method for communication, by a base station (BS) with at least one of one or more user equipment's (UEs) and one or more relay nodes is disclosed. The method comprising transmitting, by the BS, one or more downlink (DL) channel state information reference signals (CSI-RS) to at least one of the one or more UEs and the one or more relay nodes. Also, the method comprises receiving at least one of a DL channel state information (CSI) and one or more sounding reference signals (SRS) from the at least one of the one or more UEs and the one or more relay nodes. Further, the method comprises performing at least one of a single user multiple input multiple output (SU-MIMO), multi user multiple input multiple output (MU-MIMO), time division duplexing (TDD), frequency division duplexing (FDD), and code domain multiplexing of one or more UEs or relay nodes using the received at least one of a DL CSI and one or more SRS.

In another aspect of the present disclosure a base station (BS) to communicate with at least one of one or more user equipment's (UEs) and one or more relay nodes, is disclosed. The Base station comprises a base band processing unit, at least one central unit, at least one distributed unit and at least one cylindrical antenna structure. The at least one cylindrical antenna structure comprising a plurality of antenna panels, each of the plurality of antenna array columns comprises a plurality of antenna elements. Each the plurality of antenna array columns is configured to: transmit one or more downlink (DL) channel state information reference signals (CSI-RS) to at least one of the one or more UEs and one or more relay nodes; receive at least one of a DL channel state information (CSI) and one or more sounding reference signals (SRS) from the at least one of the one or more UEs and one or more relay nodes; and perform at least one of a SU-MIMO, MU-MIMO, time division duplexing (TDD), frequency division duplexing (FDD), and code domain multiplexing of one or more UEs or relay nodes.

In yet another aspect of the present disclosure a base station (BS) to communicate with at least one of one or more user equipment's (UEs) and one or more relay nodes, is provided. The BS comprising a base band processing unit, at least one central unit, at least one distributed unit and a structural MIMO (s-MIMO) arrangement. The s-MIMO arrangement comprising a plurality of antenna panels configured in both horizontal and vertical directions, each of the plurality of antenna panels comprises a plurality of antenna elements. Each the plurality of antenna panels is configured to: transmit one or more downlink (DL) channel state information reference signals (CSI-RS) to at least one of the one or more UEs and one or more relay nodes, receive at least one of a DL channel state information (CSI) and one or more sounding reference signals (SRS) from the at least one of the one or more UEs and one or more relay nodes, and perform at least one of a SU-MIMO, MU-MIMO, time division duplexing (TDD), frequency division duplexing (FDD), and code domain multiplexing of one or more UEs or relay nodes based on the received at least one of a DL CSI and one or more SRSs.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of device or system and/or methods in accordance with embodiments of the present subject matter are now described, by way of example only, and with reference to the accompanying figures, in which:

FIG. 1 shows an illustration of a wireless backhaul operation;

FIG. 2 shown an illustration of a base station (BS) with a sectoral separation method, in accordance with an embodiment of the present disclosure;

FIG. 3 shown an illustration of a base station (BS) communicating with relay nodes and/or user equipment's (UEs) using a cylindrical antenna structure, in accordance with an embodiment of the present disclosure;

FIG. 4 shows an antenna array column structure in the cylindrical antenna structure of the BS, in accordance with an embodiment of the present disclosure;

FIG. 5 shows an exemplary base station (BS) using a structural MIMO (s-MIMO) design, in accordance with an embodiment of the present disclosure;

FIG. 6 shows an example of scheduling relay nodes and UEs with SU-MIMO mode while operating in frequency division duplexing mode, in accordance with an embodiment of the present disclosure;

FIG. 7 shows an example of scheduling of resources for relay nodes and UEs with SU-MIMO mode while operating in time division duplexing mode, in accordance with an embodiment of the present disclosure;

FIG. 8 shows an illustration of scheduling of resources for relay nodes and UEs with MU-MIMO mode, in accordance with an embodiment of the present disclosure; and

FIG. 9 shows a flowchart illustrating a method for communication, by a base station (BS) with at least one of one or more user equipment's (UEs) and one or more relay nodes in a communication network, in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Embodiments of the present disclosure relate to a base station (BS) for communicating with at least of: one or more user equipment's (UEs) and one or more relay nodes. The BS is also referred to as gNB or common location or cloud site. The BS is connected with one or more relay nodes, which is also referred to a multiple relay nodes. The BS is realized using various architectures such as, but not limited to, sectoral layout, cylindrical antenna structure, and structural MIMO (s-MIMO).

In an embodiment, a downlink (DL) channel state information (CSI) obtained from the feedback and uplink CSI obtained from the sounding reference signals, the common location or the BS performs single-user or multi-user precoding to the relay nodes and/or to UEs. The design architecture is generic and a similar methodology is applied to the uplink reception, where the common location applies single-user or multi-user equalization and data detection.

The present disclosure provides a base station design architecture to support stable and efficient spatial multiplexing for the wireless back-haul. The wireless backhaul is a cost-effective solution in scenarios where the optical fibre cannot be deployed to each cell site. To realize this, a common location or cloud site is connected with multiple relay nodes with various antenna architectures at the common cloud such as cylindrical, structural, and sectoral. The different antenna array structures are designed with a large number of antenna elements forming multiple antenna ports in horizontal and vertical directions, to achieve 360 degrees of coverage in azimuth and elevation. Using an intelligent weighted combining of the antennas, very narrow beams can be formed in horizontal and vertical directions.

These narrow beams help to significantly reduce the inter-layer interference while performing the spatial multiplexing, and thus, achieve large gains in the network capacities. Further, by using downlink channel state information obtained from the feedback and uplink channel state information obtained from the sounding reference signals in uplink, the common location performs single user or multi user precoding to the relay nodes and users. The design is generic and a similar approach extends to the uplink reception where the common location applies single-user or multi-user equalization and data detection.

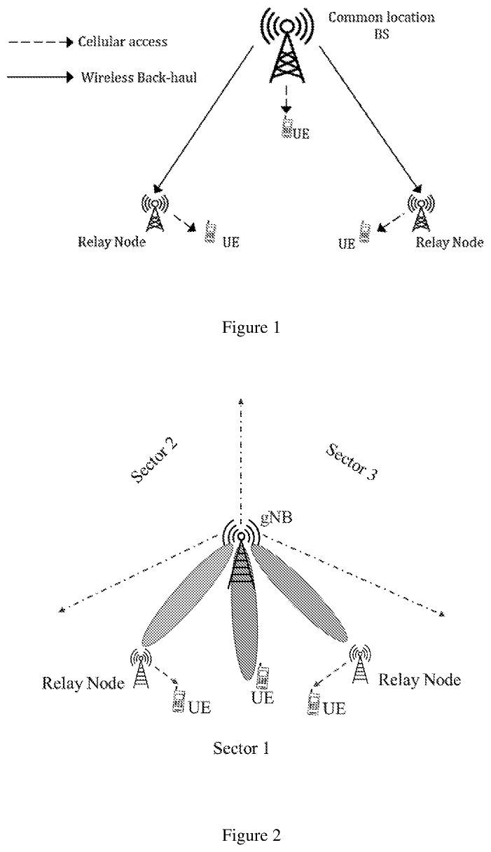

FIG. 1 shows an illustration of a wireless backhaul operation in a communication network. As shown in FIG. 1, the high-capacity wireless back-haul runs from a central location to multiple infrastructure Relay Nodes or infrastructure UEs. The central location employs a large antenna array, which comprises multiple RF chains, and performs full or part coverage in azimuth and elevation directions.

As shown in the FIG. 1, wireless backhaul operations are performed and also relay nodes establish connections with the central base station via wireless backhaul links. The relay nodes require exceptionally high data rates, and the central location must effectively support multiple such relay nodes simultaneously. Hence, there is a need for development of an architectural design which ensures stable and efficient spatial multiplexing for the wireless backhaul becomes imperative. Also, these architectures should provide spatial multiplexing strategies for achieving higher data rates and accommodating a significant number of relay nodes.

The relay nodes communicate with multiple users whose data in turn goes through the relay-back-haul connection from relay node to common cloud sites. From there, the response or the downlink data communication from a common cloud site reaches the relay nodes and is then communicated via the relay node to the multiple users. These relay nodes are placed on a fixed installed structure or can be mobile and act as moving-relay-nodes. Typically, the relay node is an integrated access backhaul (IAB UE-MT) that is connected to the IAB cell site. To achieve the high-capacity wireless back-haul, one of the BS architectural designs used is shown in

FIG. 2 shown an illustration of a base station (BS) with a sectoral separation method, in accordance with an embodiment of the present disclosure. The BS also referred as gNB (g Node B) or communication system. The BS adopts to a sectoral separation approach, dividing its coverage area into three sectors. Within each sector, there are multiple relay nodes and UEs, with each relay node providing service to multiple UEs. The gNB's transmitter is equipped with a large antenna array, enabling it to efficiently serve multiple relay nodes and UEs simultaneously. The gNB can intelligently perform single-user, multi-user, time-division, frequency-division multiplexing to schedule multiple relays and UEs.

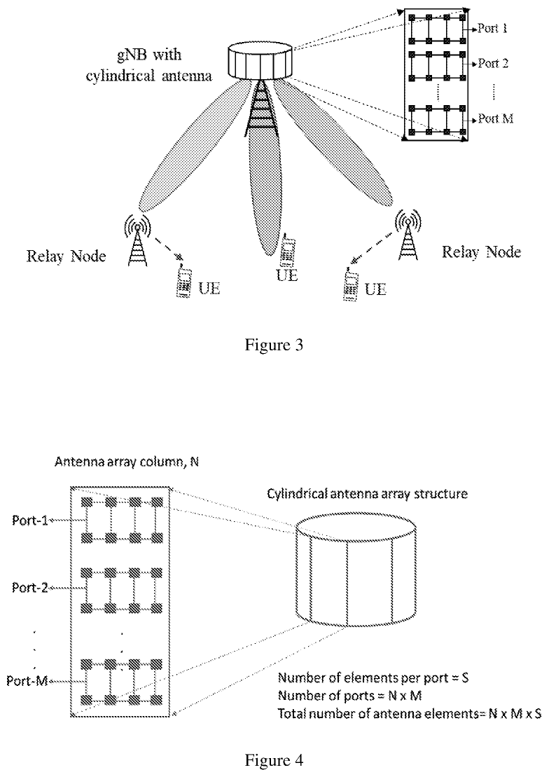

FIG. 3 shown an illustration of a base station (BS) communicating with relay nodes and/or user equipment's (UEs) using a cylindrical antenna structure, in accordance with an embodiment of the present disclosure. The BS also referred as gNB (g Node B) or communication system. FIG. 4 shows an antenna array column structure in the cylindrical antenna structure of the BS, in accordance with an embodiment of the present disclosure. The cylindrical antenna structure comprises a plurality of antenna array columns or a plurality of antenna panels. As shown in the FIG. 4, the plurality of antenna panels is placed in a structural arrangement to provide at least one of a 360-degree coverage in horizontal and 180-degree coverage in the azimuth.

The base station as shown in FIG. 3, comprises a base band processing unit, at least one central unit, at least one distributed unit and at least one cylindrical antenna structure. The at least one cylindrical antenna structure comprising a plurality of antenna panels, each of the plurality of antenna array columns comprises a plurality of antenna elements. Each the plurality of antenna array columns is configured to: transmit one or more downlink (DL) channel state information reference signals (CSI-RS) to at least one of the one or more UEs and one or more relay nodes; receive at least one of a DL channel state information (CSI) and one or more sounding reference signals (SRS) from the at least one of the one or more UEs and one or more relay nodes; and perform at least one of a SU-MIMO, MU-MIMO, time division duplexing (TDD), frequency division duplexing (FDD), and code domain multiplexing of one or more UEs or relay nodes.

The plurality of antenna panels is connected to the base band processing unit, which performs baseband processing comprising at least one of a reciprocity calibration, a single user MIMO, multi-user MIMO, beamforming and precoding and joint processing of uplink signals. In an embodiment, the BS is configured with a multiple semi-static, simultaneous radiation patterns offer coverage in a predetermined area or elevation and azimuth. The BS communicates with the one or more UEs using at least one of SU-MIMO, MU-MIMO, a TDMA, and a FDMA

In an embodiment, the BS performs a sectoral separation by dividing the coverage area into three sectors. In this configuration, the BS generates one or more semi-static, simultaneous radiation patterns for at least one sector using the one or more antenna structures. Also, The BS provides a coverage for at least one of one more UEs and one or more relay nodes in each sector, wherein at least one of the one or more UEs and one or more relay nodes are associated with one or more radiation patterns in said sector.

In an embodiment, considering the antenna array column, also referred to as antenna panel, with ‘M’ ports in the vertical direction, with each port housing ‘S’ antenna elements. Also, assuming that there is ‘N’ such columns encircling the cylindrical array. In this scenario, when M=4, N=24, and S=8, there will be 4 ports in each column, each port equipped with 8 antenna elements, and a total of 24 such columns. In this specific example, a total of 768 antenna elements are employed within this cylindrical antenna array. In practical implementation, the antenna array design can be realized by considering N rectangular array structures, each comprising M ports and M×S antenna elements, or else by directly printing the antenna elements onto the cylindrical structure.

The antenna array structure design ensures 360 degrees of coverage and also helps in achieving a narrow beam in both azimuth and elevation, for example 15-degree beam per port. While performing the MU-MIMO, these narrow beams help in reducing the interference among the multiple transmissions/layers that are transmitted simultaneously, and thus, help in achieving significant improvement in the network capacities. The corresponding antenna array method is general and extends to different configurations.

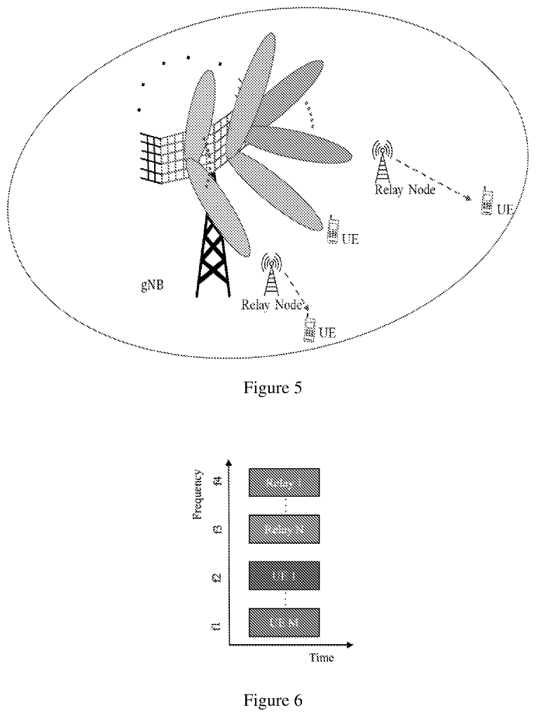

FIG. 5 shows an exemplary base station (BS) using a structural MIMO (s-MIMO) design, where the BS comprises a large number of multiple antenna panels or plurality of antenna panels, with each panel having antenna ports in horizontal and vertical directions. These large number of multiple antenna panels are placed in a structural arrangement such that they provide a 360-degree coverage in horizontal and 180-degree coverage in the azimuth. All these antenna panels are then connected to a common processing unit that performs baseband processing such as reciprocity calibration, single and multi-user MIMO, beamforming and precoding, joint processing of uplink signals, etc. The BS also referred as gNB (g Node B) or communication system.

In an embodiment, the base station as shown in FIG. 5 comprises a base band processing unit, at least one central unit, at least one distributed unit and at least one cylindrical antenna structure. The at least one cylindrical antenna structure comprising a plurality of antenna panels, each of the plurality of antenna array columns comprises a plurality of antenna elements. Each the plurality of antenna array columns is configured to: transmit one or more downlink (DL) channel state information reference signals (CSI-RS) to at least one of the one or more UEs and one or more relay nodes; receive at least one of a DL channel state information (CSI) and one or more sounding reference signals (SRS) from the at least one of the one or more UEs and one or more relay nodes; and perform at least one of a SU-MIMO, MU-MIMO, time division duplexing (TDD), frequency division duplexing (FDD), and code domain multiplexing of one or more UEs or relay nodes.

The plurality of antenna panels is connected to the base band processing unit, which performs baseband processing comprising at least one of a reciprocity calibration, a single user MIMO, multi-user MIMO, beamforming and precoding and joint processing of uplink signals. In an embodiment, the BS is configured with a multiple semi-static, simultaneous radiation patterns offer coverage in a predetermined area or elevation and azimuth. The BS communicates with the one or more UEs using at least one of SU-MIMO, MU-MIMO, a TDMA, and a FDMA

In an embodiment, the BS performs a sectoral separation by dividing the coverage area into three sectors. In this configuration, the BS generates one or more semi-static, simultaneous radiation patterns for at least one sector using the one or more antenna structures. Also, The BS provides a coverage for at least one of one more UEs and one or more relay nodes in each sector, wherein at least one of the one or more UEs and one or more relay nodes are associated with one or more radiation patterns in said sector.

As shown in the FIGS. 2, 3 and 5, in the BS architecture designs the antenna array has a generic number of sub-antenna-arrays placed in 360-degrees in azimuth and elevation. There are N ports in horizontal and M ports in a vertical direction and S antenna elements per port. These S antenna elements per port are combined using inter-antenna transmission lines resulting in a radiation pattern with less than 360-degree coverage in elevation and azimuth. All these antenna ports, antenna elements are arranged such that the BS provides 360-degree coverage in azimuth and elevation.

In an embodiment, the common cloud site or common BS or common gNB is attached to multiple relay nodes and UEs. The relay nodes are at least one among base station (BTS), local cloud cell site, IAB BTS, or Wi-Fi AP. In an embodiment, the relay nodes are either fixed relay nodes or mobile relay nodes. Each of the relay nodes further serves a plurality of UEs or other relay nodes. The data transmitted by the UEs or nodes attached to one of the relay nodes goes to the common cloud site or the common BS using wireless relay backhaul. Similarly, the communication from the common BS is transmitted to the UE using the corresponding relay node.

In an embodiment, the antenna array has columns of sub-antenna-arrays placed in 360-degrees in azimuth. There are N ports (columns) and M ports in a sub-antenna array and S antenna elements per port. The S antenna elements per port are combined using inter-antenna transmission lines resulting in a radiation pattern with less than 360-degree coverage in elevation and azimuth.

One embodiment of the present disclosure is cloud cell site. The cloud cell site comprising a plurality of radio units (RUs) arranged on a cell tower using a geometry that offers full coverage in azimuth and full or part coverage in elevation. Each radio unit comprises a plurality of antennas connected to downlink antenna ports. The plurality of RUs is interconnected by wired connection to a cloud cell site processor that performs joint signal processing and scheduling.

In an embodiment, the plurality of antennas of the cloud cell site are arranged on a cell tower using a geometry that offers full or part coverage in azimuth and elevation. The multiple antenna signals are processed to result in antenna ports. The multiple antenna port signals carried by fibre to a cloud cell site processor that performs joint signal processing and scheduling. The antennas of the radio units are arranged in geometry that includes one of circular, semi-circular, cylindrical, cube, polyhedron, and spatially distributed.

The cloud cell site includes a processor which is attached with one or more infrastructure relay nodes. The infrastructure relay node acts as a relay-back-haul that is connected to a transmitting node that is at least one of a BTS, local cloud cell site, IAB BTS, or Wi-Fi AP. The infrastructure relay nodes are placed on a fixed installation or can be mobile relay nodes. The common location or cloud cell site includes a IAB donor Distributed Unit (DU). In an embodiment, the relay node is a IAB UE-MT that is connected to the IAB cell site. The relay node further serves multiple users. The transmitting node serves the users whose data goes through the relay-back-haul to reach the cloud cell site.

One embodiment of the present disclosure is an implementation of common beam with various BS or gNB architectures. In general, the narrow beams are required only in case of the user specific transmissions. For all the transmissions that are specific to a cell, the base station has to schedule a common beam which has uniform coverage in both azimuth and elevation. For example, the primary and secondary synchronization signals (PSS and SSS), physical broadcast channel (PBCH), physical downlink control channel (PDCCH), physical random-access channel (PRACH), and sounding-reference signals (SRS), have to be transmitted through a common beam. The common beam has to cover the entire 360 degrees in the azimuth and 180 degrees in the vertical to ensure uniform coverage to high rise buildings and operation of drones, etc. In the elevation, this can be accomplished by having two vertical beams covering [0 to 90 degrees] and [90 to 180 degrees], respectively. Then, for all the common beam transmissions, the same data transmission has to happen across all the active beams. A similar approach can be applied in azimuth to achieve 360 degrees of coverage. With the proposed gNB architectures and 360-degree coverage in azimuth and elevation, the capacity of control channels in uplink and downlink (PUCCH and PDCCH) can be significantly increased to a large number.

The cell site configures antenna array using signal processing to have a user specific beam to serve signals corresponding to data or control of one or more users in downlink or uplink. The cell site serves one of more users in one of downlink and uplink using signal processing. The signal processing includes weighing and combining of at least one of transmit or receiver signals. The signal processing is at least one of digital and analog processing. In an embodiment, the signal processing results in one or more beams in elevation and azimuth.

In an embodiment, the cell site configures the antenna array using signal processing to have multiple beams in azimuth spanning 360-degrees and one beam in the elevation to offer directed coverage using a vertical tilt. Also, the cell site configures the antenna array using signal processing to have multiple beams in azimuth spanning 360-degrees and multiple beams in the elevation to offer directed coverage using a vertical tilt. The cell site configures the antenna array using signal processing to have a common beam.

The common beam with 360 coverage in azimuth and a directed coverage in elevation with a vertical tilt. The signals include common physical channels that are transmitted or received using the common beam. The transmit physical channels are one of primary synchronization signal (PSS), secondary synchronization signal (SSS), physical broadcast channel (PBCH) and physical downlink control channel (PDCCH) and cell search signals. The receiver physical channels are one of physical random-access channel (PRACH), sounding reference signals (SRS), physical uplink control channel (PUCCH) and control channels.

One embodiment of the present disclosure is a channel state information (CSI) acquisition and precoding. The infrastructure relay nodes use the BTS grade transmitter/receiver antennas and power amplifiers, in order to support high link budget when compared to the normal user-equipment. The common cloud cell site transmits downlink CSI reference signals from each downlink antenna port with a periodicity. The static relay nodes infrequently transmit the exact downlink CSI and frequently transmit the sounding reference signals (SRS) to the central location. Further, each of the scheduled nodes transmits SRS from each antenna port and each of the scheduled node feeds back explicit downlink CSI in uplink with low periodicity or based on explicit request by cloud cell.

The common cloud site uses the explicit downlink CSI feedback by a UE and an SRS received in the uplink to calculate the calibration coefficients initially. Also, the common cloud site uses these coefficients to calibrate the next downlink CSI by applying these coefficients on the very latest SRS received in the uplink. Using these estimates, the common cloud determines the subset of multiple relay nodes and UEs to be paired as part of subsequent transmissions.

The central location exploits this information to apply multi-user MIMO (MU-MIMO) to enable highly reliable and nearly interference-free links to the infrastructure relay nodes. The ability to achieve such interference-free links relies on the geographical separation between the relay nodes (distinct angular separation in azimuth and elevation directions). With the large antenna array at the common location and when the relay nodes are spatially well separated, each relay node enjoys nearly a full-benefit of having an exclusive link in spite of multiple relay nodes sharing the same time-frequency resources. The relay nodes at the time of installation are ensured to have highly stable (low outages) and reliable back-haul.

Further, the common cloud site or the common BS/gNB performs at least one of single user, or multi-user transmissions, or mix of both to communicate with multiple relay nodes and UEs. The common gNB uses either time division duplexing, frequency division duplexing, or code-domain multiplexing of multiple relay nodes and UEs.

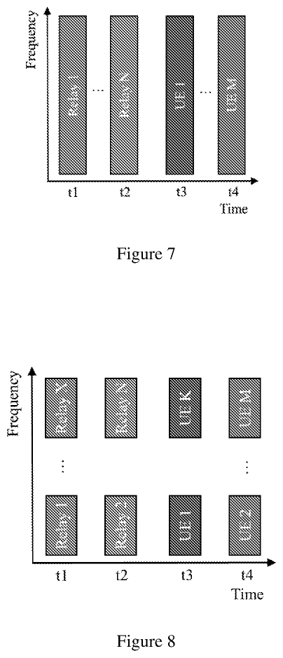

FIG. 6 shows an example of scheduling relay nodes and UEs with SU-MIMO mode while operating in frequency division duplexing mode. The resources for communicating with relay nodes and UEs are orthogonal to each other in frequency domain. FIG. 7 shows an example of scheduling of resources for relay nodes and UEs with SU-MIMO mode while operating in time division duplexing mode.

With CSI-RS feedback and SRS reception at the common cloud, the gNB performs pairing of relay nodes and UEs for simultaneous data transmission. The common cloud can pick the relay nodes and UEs that are spatially well separated and pair them on particular time/frequency resources. These paired relay nodes and users share the same time/frequency resources, and thus, enable common cloud achieve high network capacities. A sample example of performing MU-MIMO on relay nodes and UEs is shown in FIG. 8.

Similarly, all the above procedures as shown in FIGS. 5-8 are applied in the uplink direction with common cloud cell site applying single user or multi-user equalization and data detection in uplink.

In an embodiment, a multi-user precoding is a function of infrequent explicit downlink CSI feedback from infrastructure relay nodes and frequent SRS signals transmitted by infrastructure relay nodes. The relay nodes transmit associated SRS in uplink with a periodicity. The cloud cell site transmits downlink CSI reference signals from each downlink antenna port with a periodicity. Each of the scheduled nodes transmits SRS from each antenna port. Each of the scheduled node feeds back explicit downlink CSI in uplink with low periodicity or based on explicit request by cloud cell.

The SRS and explicit CSI feedback are transmitted by the node are in same subframe or frame. Explicit CSI duration is full band with one sample per sub-band. The sub-band duration is an integer multiple of physical resource blocks. The explicit CSI feedback values based on one of frequency domain I/Q quantized CSI, time domain I/Q quantized CSI, code book-based CSI. The cloud cell uses explicit downlink CSI and the associated estimated uplink SRS based CSI to obtain calibration coefficients at a first time. The cloud cell receives SRS at a second time. The second SRS is used to estimate second uplink CSI. The cloud cell uses calibration coefficients to calibrate the second uplink CSI to obtain second estimated downlink CSI.

The second estimated downlink CSI is used to determine the subset of relay nodes and the associated ports that will be paired. The selected relay nodes and their ports are signalled to the relay nodes. The second estimated downlink CSI is used to perform one of single user and multi user MIMO precoding of scheduled relay nodes.

The Cloud cell site processor applies single user or multi-user precoding on a subset of one or more infrastructure nodes in the downlink. The cloud cell site processor applies single user or multi-user equalization and data detection in uplink. The relay node may apply precoding weights to it transmit antennas and announce one or more ports.

One embodiment of the present disclosure is implementation of single user (SU)/ multi-user (MU) MIMO with the proposed antenna array. For the user specific data transmissions like physical downlink shared channel (PDSCH), single-user or multi-user MIMO (SU/MU-MIMO) can be applied by utilizing the total all the available ports, each with a narrow beam.

For the TDD-scenarios, the base station can use the SRS based reciprocity and use the narrow beams in the downlink to perform a more effective MU-MIMO beamforming on the PDSCH. While performing the MU-MIMO, the narrow beams achieved with proposed design help in reducing the interference among the multiple layers, and thus, help in achieving significant improvement in the network capacities. Similar to the downlink, the MU-MIMO beamforming of order M×N can be applied in the uplink for physical uplink shared channel (PUSCH).

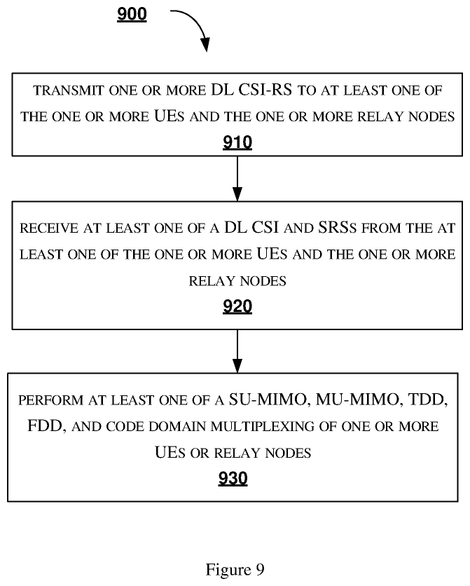

FIG. 9 shows a flowchart illustrating a method for communication, by a base station (BS) with at least one of one or more user equipment's (UEs) and one or more relay nodes in a communication network, in accordance with some embodiments of the present disclosure.

As illustrated in FIG. 9, the method 900 comprises one or more blocks for communication by the BS with at least one of one or more user equipment's (UEs) and one or more relay nodes. The method 900 may be described in the general context of computer executable instructions. Generally, computer executable instructions can include routines, programs, objects, components, data structures, procedures, modules, and functions, which perform functions or implement abstract data types.

The order in which the method 900 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 910, transmitting, by the BS, one or more downlink (DL) channel state information reference signals (CSI-RS) to at least one of the one or more UEs and the one or more relay nodes.

At block 920, receiving, by the BS, at least one of a DL channel state information (CSI) and one or more sounding reference signals (SRS) from the at least one of the one or more UEs and the one or more relay nodes. The BS is configured in one of a cylindrical antenna structure, a sectoral separation structure and a structural MIMO antenna structure. The sectoral separation structure comprises performing a sectoral separation by dividing the coverage area into three sectors. Also, the method comprises generating one or more semi static patterns, one or more simultaneous beams or radiation patterns for each sector.

The BS is configured with a multiple semi-static, simultaneous radiation patterns offer coverage in a predetermined area or elevation and azimuth, in an embodiment.

At block 930, performing, by the BS, at least one of a SU-MIMO, MU-MIMO, time division duplexing (TDD), frequency division duplexing (FDD), and code domain multiplexing of one or more UEs or relay nodes using the received at least one of a DL CSI and one or more SRS.

In an embodiment, the BS performs communication with the one or more UEs using at least one of MU-MIMO among one or more UEs, TDMA among one or more UEs, and FDMA among one or more UEs.

In an embodiment, the method 900 comprises generating at least one of: one or more semi-static and simultaneous radiation patterns for at least one sector using the one or more antenna structures. Also, the method comprises processing information associated with at least one sector and provide TDD reciprocity calibration. The information is at least one of a one of more signals associated with one or more semi-static, simultaneous radiation patterns.

In an embodiment, the method comprising providing coverage for at least one of one more UEs and one or more relay nodes in each sector, wherein at least one of the one or more UEs and one or more relay nodes are associated with one or more beams/radiation patterns in said sector.

Further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

A description of an embodiment with several components in communication with each other does not imply that all such components are required. On the contrary a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description. Accordingly, the disclosure of the embodiments of the invention is intended to be illustrative, but not limiting, of the scope of the invention.

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A method for communication, by a base station (BS) with at least one of one or more user equipment's (UEs) and one or more relay nodes, the method comprising:
transmitting, by the BS, one or more downlink (DL) channel state information reference signals (CSI-RS) to at least one of the one or more UEs and the one or more relay nodes;
receiving, by the BS, at least one of a DL channel state information (CSI) and one or more sounding reference signals (SRS) from the at least one of the one or more UEs and the one or more relay nodes; and
performing, by the BS, at least one of a SU-MIMO, MU-MIMO, time division duplexing (TDD), frequency division duplexing (FDD), and code domain multiplexing of one or more UEs or relay nodes using the received at least one of a DL CSI and one or more SRS.

2. The method as claimed in claim 1, wherein the BS is configured with a multiple semi-static, simultaneous radiation patterns offer coverage in a predetermined area or elevation and azimuth.

3. The method as claimed in claim 1, wherein the BS is configured in one of a cylindrical antenna structure and a structural MIMO antenna structure.

4. The method as claimed in claim 1, wherein the method comprises communicating by the BS with the one or more UEs, said communicating is performed using at least one of MUMIMO among one or more UEs, TDMA among one or more UEs, and FDMA among one or more UEs.

5. The method as claimed in claim 1, wherein the method comprises performing a sectoral separation by dividing the coverage area into three sectors.

6. The method as claimed in claim 3, wherein the method comprises generating at least one of one or more semi-static and simultaneous radiation patterns for at least one sector using the one or more antenna structures.

7. The method as claimed in claim 3, wherein the method comprises processing information associated with at least one sector and provide TDD reciprocity calibration;
said information is at least one of a one of more signals associated with one or more semi-static, simultaneous radiation patterns.

8. The method as claimed in claim 3, wherein the method comprises generating one or more semi static patterns, one or more simultaneous beams or radiation patterns for each sector.

9. The method as claimed in claim 3, wherein the method comprising providing coverage for at least one of one more UEs and one or more relay nodes in each sector, wherein at least one of the one or more UEs and one or more relay nodes are associated with one or more radiation patterns in said sector.

10. A base station (BS) to communicate with at least one of one or more user equipment's (UEs) and one or more relay nodes, said BS comprising:
a base band processing unit;
at least one central unit;
at least one distributed unit; and
at least one cylindrical antenna structure comprising a plurality of antenna panels, each of the plurality of antenna array columns comprises a plurality of antenna elements;
wherein each the plurality of antenna array columns is configured to:
transmit one or more downlink (DL) channel state information reference signals (CSI-RS) to at least one of the one or more UEs and one or more relay nodes;
receive at least one of a DL channel state information (CSI) and one or more sounding reference signals (SRS) from the at least one of the one or more UEs and one or more relay nodes; and
perform at least one of a SU-MIMO, MU-MIMO, time division duplexing (TDD), frequency division duplexing (FDD), and code domain multiplexing of one or more UEs or relay nodes.

11. The base station as claimed in claim 10, wherein the plurality of antenna panels are placed in a structural arrangement to provide at least one of a 360-degree coverage in horizontal and 180-degree coverage in the azimuth.

12. The BS as claimed in claim 10, wherein the plurality of antenna panels are connected to the base band processing unit, which performs baseband processing comprising at least one of a reciprocity calibration, a single user MIMO, multi-user MIMO, beamforming and precoding and joint processing of uplink signals.

13. The BS as claimed in claim 10, wherein the BS is configured with a multiple semi-static, simultaneous radiation patterns offer coverage in a predetermined area or elevation and azimuth.

14. The BS as claimed in claim 10, wherein the BS communicates with the one or more UEs using at least one of SU-MIMO, MU-MIMO, a TDMA, and a FDMA.

15. The BS as claimed in claim 10, wherein the BS performs a sectoral separation by dividing the coverage area into three sectors.

16. The BS as claimed in claim 15, wherein the BS generates one or more semi-static, simultaneous radiation patterns for at least one sector using the one or more antenna structures.

17. The BS as claimed in claim 15, wherein the BS provides a coverage for at least one of one more UEs and one or more relay nodes in each sector, wherein at least one of the one or more UEs and one or more relay nodes are associated with one or more radiation patterns in said sector.

18. A base station (BS) to communicate with at least one of one or more user equipment's (UEs) and one or more relay nodes, said BS comprising:
a base band processing unit;
at least one central unit;
at least one distributed unit; and
a structural MIMO (s-MIMO) arrangement comprising a plurality of antenna panels configured in both horizontal and vertical directions, each of the plurality of antenna panels comprises a plurality of antenna elements;
wherein each the plurality of antenna panels is configured to:
transmit one or more downlink (DL) channel state information reference signals (CSI-RS) to at least one of the one or more UEs and one or more relay nodes;
receive at least one of a DL channel state information (CSI) and one or more sounding reference signals (SRS) from the at least one of the one or more UEs and one or more relay nodes; and
perform at least one of a SU-MIMO, MU-MIMO, time division duplexing (TDD), frequency division duplexing (FDD), and code domain multiplexing of one or more UEs or relay nodes based on the received at least one of a DL CSI and one or more SRSs.

19. The base station as claimed in claim 18, wherein the plurality of antenna panels are placed in a structural arrangement to provide at least one of a 360-degree coverage in horizontal and 180-degree coverage in the azimuth.

20. The BS as claimed in claim 18, wherein the plurality of antenna panels are connected to the base band processing unit, which performs baseband processing comprising at least one of a reciprocity calibration, a single user MIMO, multi-user MIMO, beamforming and precoding and joint processing of uplink signals.

21-25. (canceled)
